(19) United States
(12) Patent Application Publication
(10) Pub. No.: US 2013/0044384 A1
(43) Pub. Date: Feb. 21, 2013

(54) COLOR FILTER SUBSTRATE EMBEDDED WITH TOUCH SENSOR AND METHOD FOR MANUFACTURING THE SAME

(71) Applicants: Young Jae Kim, Gyunggi-do (KR); Ha Yoon Song, Gyunggi-do (KR); Ho Joon Park, Seoul (KR)

(72) Inventors: Young Jae Kim, Gyunggi-do (KR); Ha Yoon Song, Gyunggi-do (KR); Ho Joon Park, Seoul (KR)

(73) Assignee: SAMSUNG ELECTRO-MECHANICS CO., LTD., Gyunggi-do (KR)

(21) Appl. No.: 13/305,615

(22) Filed: Nov. 28, 2011

(30) Foreign Application Priority Data
Aug. 19, 2011 (KR) 1020110082873

(51) Int. Cl. G02B 5/20; B32B 37/12; B05D 5/06; B05D 5/12; B32B 37/14

(52) U.S. Cl. 359/885; 427/58; 156/60

(57) ABSTRACT

Disclosed herein is a color filter substrate embedded with a touch sensor, including: a transparent substrate; a metal mesh electrode formed on the transparent substrate; and a black matrix layer formed on the metal mesh electrode to correspond to a shape of the metal mesh electrode and having at least one opening area formed therein. According to the present invention, the metal mesh electrode and the black matrix are overlapped to be matched with each other, thereby making it possible to solve a moire phenomenon.

### CROSS REFERENCE TO RELATED APPLICATION

This application claims the benefit of Korean Patent Application No. 10-2011-0082873, filed on Aug. 19, 2011, entitled “Touch Sensor And Method For Manufacturing The Same” which is hereby incorporated by reference in its entirety into this application.

### BACKGROUND OF THE INVENTION

1. Technical Field

The present invention relates to a color filter substrate embedded with a touch sensor and a method for manufacturing the same.

2. Description of the Related Art

In accordance with the growth of computers using a digital technology, devices assisting computers have also been developed, and personal computers, portable transmitters and other personal information processors execute processing of text and graphics using a variety of input devices such as a keyboard and a mouse. While the rapid advancement of an information-oriented society has been widening the use of computers more and more, it is difficult to efficiently operate products using only a keyboard and mouse currently serving as an input device. Therefore, the necessity for a device that is simple, has minimum malfunction, and is capable of easily inputting information has increased. In addition, current techniques for input devices have progressed toward techniques related to high reliability, durability, innovation, designing and processing beyond the level of satisfying general functions. To this end, a touch panel has been developed as an input device capable of inputting information such as text, graphics, or the like. This touch panel is mounted on a display surface of an image display device such as an electronic organizer, a flat panel display device including a liquid crystal display (LCD) device, a plasma display panel (PDP), an electroluminescence (El) element, or the like, or a cathode ray tube (CRT) to thereby be used to allow a user to select desired information while viewing the image display device.

FIG. 1 is a cross-sectional view of a touch panel 100 according to the prior art. The touch panel 100 includes transparent electrodes 121 and 122 and electrode wirings 131 and 132 formed on glass substrates 111 and 112. As the transparent electrodes 121 and 122, indium thin oxide (ITO) has been primarily used up to now. In consideration of a tendency of extension of a demand for application products associated with excellent characteristics of ITO as the transparent electrodes 121 and 122, it is expected that a consumption amount of this material will increase gradually from now on. However, indium configuring ITO is one of representative rare exhausted resources and a supply amount thereof significantly has decreased. According to specialists, indium will be exhausted from 10 years to 25 years. The reason is that rareness is high because indium is rectified with a by-product of zinc ore. A rapid increase in price of indium causes an increase in a manufacturing cost of the related application product even before indium is exhausted, such that the development of a new transparent conductive film that does not include indium is very urgent.

Meanwhile, FIG. 2 is a cross-sectional view of an image display device 300 according to the prior art. The image display device 300 of FIG. 2 is configured by combining a touch panel 100 according to FIG. 1 with a color filter substrate 200. A black matrix layer 220 is formed on a support substrate 210 and red, green, and blue color filters 230 are applied to an opening area of the black matrix layer 220 to configure the color filter substrate 200. The touch panel 100 and the color filter substrate 200 are combined with each other by an adhesive layer 250. However, in the image display device 300 having such a structure, a manufacturing process of the touch panel 100 and a manufacturing process of the color filter substrate 200 are separately performed and a process of adhering the touch panel 100 and the color filter substrate 200 to each other is then performed. Therefore, the manufacturing process is somewhat complicated and a manufacturing time is long. Further, the overall thickness of the image display device 300 increases. In particular, since both components are separately manufactured, an unnecessary component such as the support substrate 210, the adhesive layer 250, or the like, is inefficiently used to thereby waste the manufacturing cost.

### SUMMARY OF THE INVENTION

The present invention has been made in an effort to provide a color filter substrate embedded with a touch sensor that can make an image display device thin by embedding a touch sensor in a color filter substrate, simplify a manufacturing process and save a manufacturing cost by integrally forming a color filter substrate and a touch sensor, and solve a moire phenomenon by overlapping a metal mesh electrode with a black matrix to be matched with the black matrix.

According to a preferred embodiment of the present invention, there is provided a color filter substrate embedded with a touch sensor, including: a transparent substrate; a metal mesh electrode formed on the transparent substrate; and a black matrix layer formed on the metal mesh electrode to correspond to a shape of the metal mesh electrode and having at least one opening area formed therein.

The color filter substrate may further include a color filter formed to correspond to the opening area of the black matrix layer and to be partially overlapped with the black matrix layer.

The metal mesh electrode may include: a first metal mesh electrode formed on the transparent substrate; an insulating layer formed on the first metal mesh electrode; and a second metal mesh electrode formed on the insulating layer.

The second metal mesh electrode may have the same shape as that of the first metal mesh electrode and may be overlapped to be matched with the first metal mesh electrode.

The insulating layer may have a shape corresponding to those of the first and second metal mesh electrodes.

The black matrix may have a shape corresponding to those of the first and second metal mesh electrodes and may be overlapped to be matched with the first and second metal mesh electrodes.

The second metal mesh electrode and the black matrix layer may be adhered by an adhesive layer.

According to a preferred embodiment of the present invention, there is provided a method for manufacturing a color filter substrate embedded with a touch sensor, including: providing a transparent substrate and forming a metal mesh electrode on the transparent substrate; forming a black matrix layer with at least one opening area on the metal mesh electrode; and forming a color filter to correspond to the opening area of the black matrix layer and to be partially overlapped with the black matrix layer.

The metal mesh electrode and the black matrix layer may be stacked to have shapes corresponding to each other.

According to a preferred embodiment of the present invention, there is provided a method for manufacturing a color filter substrate embedded with a touch sensor, including: providing a transparent substrate and forming a first metal mesh electrode on a surface of the transparent substrate; forming an insulating layer on the first metal mesh electrode to correspond to the first metal mesh electrode; forming a second metal mesh electrode on the insulating layer to correspond to the insulating layer; and forming a black matrix layer having a predetermined opening area on the second metal mesh electrode.

The second metal mesh electrode may have a shape corresponding to that of the first metal mesh electrode and may be, overlapped to be matched with the first metal mesh electrode.

The black matrix layer may have a shape corresponding to thoes of the first and second metal mesh electrodes and may be overlapped to be matched with the first and second metal mesh electrodes.

The forming of the black matrix layer having the predetermined opening area on the second metal mesh electrode may include: forming an adhesive layer on the second metal mesh electrode; and stacking the black matrix layer on the adhesive layer.

### BRIEF DESCRIPTION OF THE DRAWINGS

FIG. 1 is a cross-sectional view of a touch panel according to the prior art;

FIG. 2 is a cross-sectional view of an image display device according to the prior art;

FIG. 3 is a cross-sectional view of a color filter substrate embedded with a touch sensor according to a preferred embodiment of the present invention;

FIG. 4 is a cross-sectional view of a color filter substrate embedded with a touch sensor according to another preferred embodiment of the present invention;

FIG. 5 is a plan view of the color filter substrate embedded with the touch sensor of FIG. 4;

FIG. 6 is a bottom view of the color filter substrate embedded with the touch sensor of FIG. 4;

FIGS. 7 to 10 are diagrams showing a method for manufacturing a color filter substrate embedded with a touch sensor according to a preferred embodiment of the present invention in accordance with a process sequence; and

FIGS. 11 to 16 are diagrams showing a method for manufacturing a color filter substrate embedded with a touch sensor according to another preferred embodiment of the present invention in accordance with a process sequence.

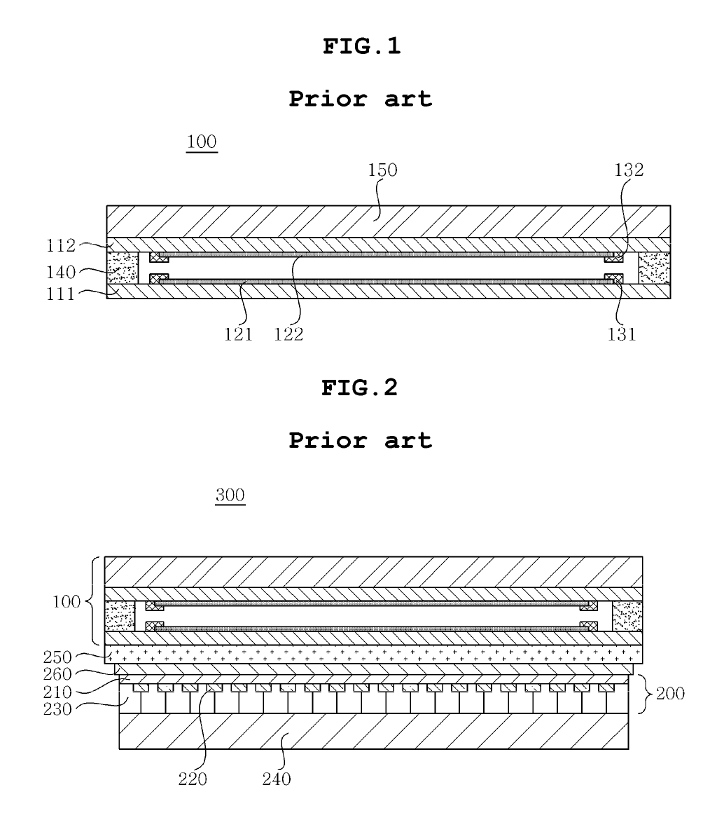

### DESCRIPTION OF THE PREFERRED EMBODIMENTS

The above and other objects, features and advantages of the present invention will be more clearly understood from the following detailed description taken in conjunction with the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

Various objects, advantages and features of the invention will become apparent from the following description of embodiments with reference to the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, preferred embodiments of the present invention will be described in detail with reference to the accompanying drawings.

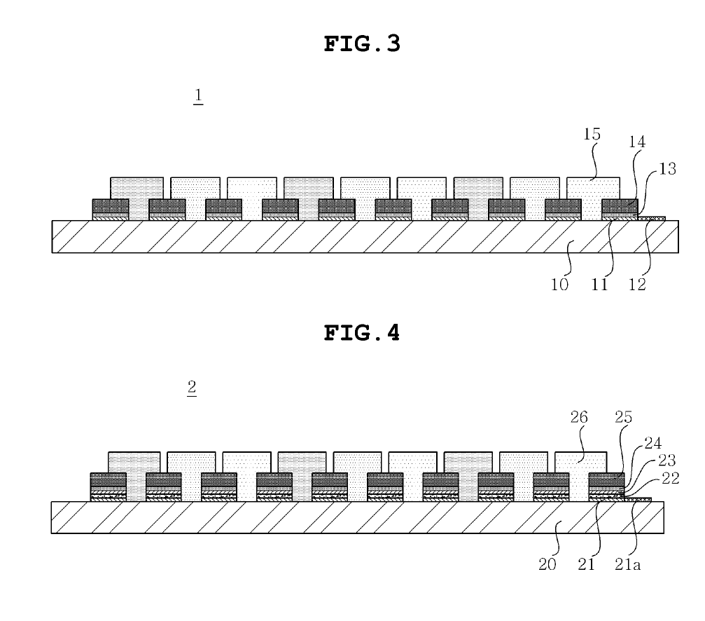

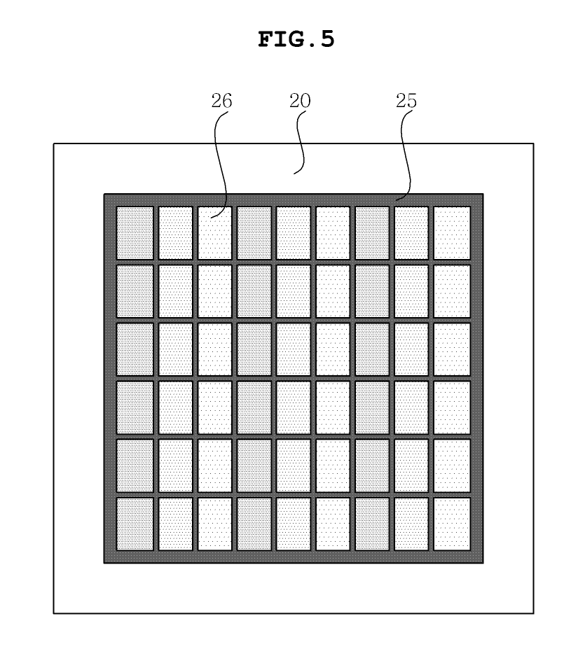

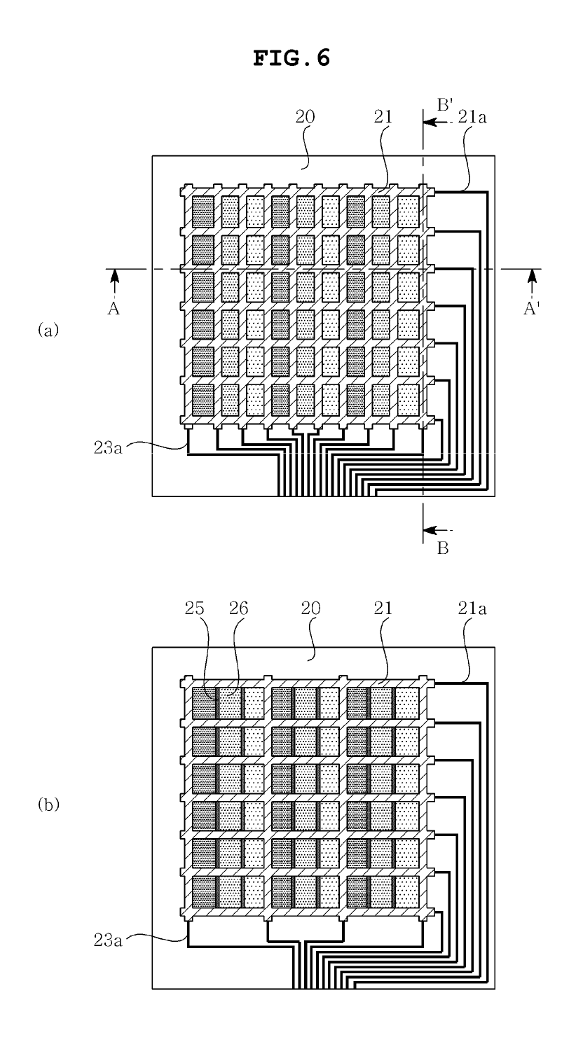

FIG. 3 is a cross-sectional view of a color filter substrate embedded with a touch sensor according to a preferred embodiment of the present invention, FIG. 4 is a cross-sectional view of a color filter substrate embedded with a touch sensor according to another preferred embodiment of the present invention, FIG. 5 is a plan view of the color filter substrate embedded with the touch sensor of FIG. 4, and FIG. 6 is a bottom view of the color filter substrate embedded with the touch sensor of FIG. 4.

The color filter substrate embedded with a touch sensor according to a preferred embodiment of the present invention includes a transparent substrate 10, a metal mesh electrode 11 formed on the transparent substrate 10, and a black matrix layer 14 formed on the metal mesh electrode 11 to correspond to the shape of the metal mesh electrode 11 and having at least one opening area formed therein.

The transparent substrate 10 basically provides an area where the metal mesh electrode 11 and the electrode wiring 12 are to be formed. The transparent substrate 10 according to the preferred embodiment of the present invention particularly serves to provide an area where the black matrix layer 14 and the color filter 15 are to be formed. Herein, the transparent substrate 10 is partitioned into an active region and a bezel region. The active region, which is a part where the metal mesh electrode 11 is formed to recognize a touch of an input module, is provided at the center of the transparent substrate 10, and the bezel region, which is a part where the electrode wiring 12 in electrical communication with the metal mesh electrode 11 is formed, is provided on the periphery of the active region. In this case, the transparent substrate 10 needs to have a supporting force to support the metal mesh electrode 11 and the electrode wiring 12 and transparency to allow a user to recognize an image provided by the image display device. In consideration of the above-mentioned supporting force and transparency, the transparent substrate 10 may be made of polyethylene terephthalate (PET), polycarbonate (PC), polymethyl metahacrylate (PMMA), polyethylene naphthalate (PEN), polyether sulfone (PES), cycloolefin polymer (COC), triacetylcellulose (TAC) film, polyvinyl alcohol (PVA) film, polyimide (PI) film, polystyrene (PS), biaxially oriented polystyrene (BOPS; containing K resin), glass or tempered glass, and so on, but is not particularly limited thereto.

The metal mesh electrode 11, which generates a signal when it is touched by the metal mesh electrode 11 to allow a controller to recognize a touch coordinate, is formed in the active region of the transparent substrate 10. A pattern of the metal mesh electrode 11 has a net shape in which a plurality of unit electrode lines having minute widths are arranged in parallel in a transverse direction and a longitudinal direction to cross each other vertically. The shape feature of the metal mesh electrode 11 is to solve an overall problem in visibility by a user, which is caused due to an opaque metallic electrode used instead of the transparent electrode made of ITO, or the like.

The electrode wiring 12 that receives an electrical signal from the metal mesh electrode 11 is printed on the periphery of the metal mesh electrode 11. In this case, the electrode wiring 12 may be printed by using screen printing, gravure printing, inkjet printing, or the like. Further, a material composed of silver (Ag) paste or organic silver having high electrical conductivity may be used as a material of the electrode wiring 12, but is not limited thereto and low-resistance metal such as a conductive polymer, carbon black (containing CNT), metal oxide such as ITO, metals, or the like, may be used.

The black matrix layer 14 is formed on the metal mesh electrode 11, and a color filter 15 is applied to the transparent substrate 10 exposed by the opening area formed in the black matrix layer 14. In general, the black matrix layer 14 with the opening areas that are formed regularly and the color filter 15 formed in the opening areas of the black matrix layer 14 are provided on a color filter substrate. The black matrix layer 14 divides the transparent substrate 10 into the plurality of opening areas where the color filters 15 are formed to prevent light interference among the adjacent opening areas and block external light. Further, an overcoat layer (not shown) may be further applied in order to flatten the surface of the color filter 15, as necessary. The metal mesh electrode 11 and the black matrix layer 14 may be adhered to each other by an adhesive layer 13 and an adhesion method is not particularly limited.

FIG. 4 is a cross-sectional view of a color filter substrate embedded with a touch sensor according to another preferred embodiment of the present invention.

In the color filter substrate embedded with a touch sensor according to another preferred embodiment of the present invention, the metal mesh electrode according to the preferred embodiment described above is formed as a first metal mesh electrode 21 and a second metal mesh electrode 23.

Hereinafter, a detailed description of the same components as those in the color filter substrate embedded with a touch sensor according to the preferred embodiment will be omitted.

The metal mesh electrodes 21 and 23, which generate the signal when they are touched by the input module to allow the controller to recognize touch coordinates, are formed in the active region of the transparent substrate 20. That is, the first metal mesh electrode 21 is formed on the surface of the transparent substrate 20. The second metal mesh electrode 23 is overlapped with the first metal mesh electrode 21. An insulating layer 22 is interposed between the first metal mesh electrode 21 and the second metal mesh electrode 23 to electrically insulate the first and second metal mesh electrodes from each other. A pattern of the first metal mesh electrode 21 has the net shape in which the plurality of unit electrode lines having minute widths are arranged in parallel in the transverse direction and the longitudinal direction to cross each other vertically. A pattern of the second metal mesh electrode 23 also has the net shape in which the plurality of unit electrode lines having minute widths are arranged in parallel in the transverse direction and the longitudinal direction to cross each other vertically. In this case, the pattern of the second metal mesh electrode 23 has the same shape as the pattern of the first metal mesh electrode 21. Furthermore, the second metal mesh electrode 23 may be overlapped with the first metal mesh electrode 21 to be matched with the first metal mesh electrode 21. The reason is that when the opaque metallic electrode is used instead of the transparent electrode made of ITO, an image projected to a user's view may be interfered or distorted due to the opaque metallic electrode and in particular, an interference pattern (moire) may occur due to line overlapping with the adjacent unit electrode lines that are repetitively arranged. Accordingly, the shape of the first metal mesh electrode 21 coincides with that of the second metal mesh electrode 23 and the both layers of metal mesh electrodes are designed to be overlapped to be matched with each other to thereby minimize the distortion of the image and the moire phenomenon.

Electrode wirings 21a and 23a include a first electrode wiring 21a extended from the first metal mesh electrode 21 and formed on the surface of the transparent substrate 20 and a second electrode wiring 23a extended from the second metal mesh electrode 23 and formed on the surface of the transparent substrate 20. In this case, since the second metal mesh electrode 23 is formed not directly on the surface of the transparent substrate 20 but on the insulating layer 22 stacked on the first metal mesh electrode 21, the second metal mesh electrode 23 needs to be insulated from the first metal mesh electrode 21. Therefore, after an insulating material 23b (see FIG. 13) is formed on the side of the first metal mesh electrode 21, the second electrode wring 23a is formed on the insulating material 23b and is extended onto the surface of the transparent substrate 20.

The black matrix layer 25 is formed on the second metal mesh electrode 23 and the color filter 26 is applied to the transparent substrate 20 exposed by the opening area formed in the black matrix layer 25. In general, the black matrix layer 25 with the opening areas that are formed regularly and the color filter 26 formed in the opening areas of the black matrix layer 25 are provided on the color filter substrate. The black matrix layer 25 divides the transparent substrate 20 into the plurality of opening areas where the color filters 26 are formed to prevent light interference among the adjacent opening areas and block external light. Further, the overcoat to layer (not shown) may be further applied in order to flatten the surface of the color filter 26, as necessary.

The above-mentioned moire phenomenon is generated between the metal mesh electrodes and is problematic even between the metal mesh electrode and the black matrix layer 25. As shown in FIG. 5, the opening areas are formed at regular intervals in the black matrix layer 25 and the R, G, and B color filters 26 applied to the opening areas are separated from each other. A pattern of the black matrix layer 25 also has a matrix shape in which black lines separating the color filter 26 in the longitudinal direction and black lines separating the color filter 26 in the transverse direction cross each other vertically. When the net-shaped pattern of the metal mesh electrode is overlapped with the matrix-shaped pattern of the black matrix layer 25, the shape of the black matrix layer 25 coincides with those of the first metal mesh electrode 21 and the second metal mesh electrode 23 and the black matrix layer 25 is designed to be overlapped to be matched with the two metal mesh electrodes 21 and 23 to thereby minimize the distortion of the image and the moire phenomenon. The adhesive layer 24 is interposed between the black matrix layer 25 and the second metal mesh electrode 23 to combine both components with each other.

However, as shown in FIG. 6A, the metal mesh electrodes 21 and 23 and the black matrix layer 25 may be overlapped with each other so that the pattern shapes (including a line width and a width from the adjacent unit electrode line} of the metal mesh electrodes 21 and 23 are completely the same as that of the black matrix layer 25, but the longitudinal black lines and the transverse black lines constituting the black matrix layer 25 do not all coincide with the longitudinal unit electrode lines and the transverse unit electrode lines of the metal mesh electrodes. That is, as shown in FIG. 6B, the metal mesh electrode may be partially overlapped with the black matrix layer 25.

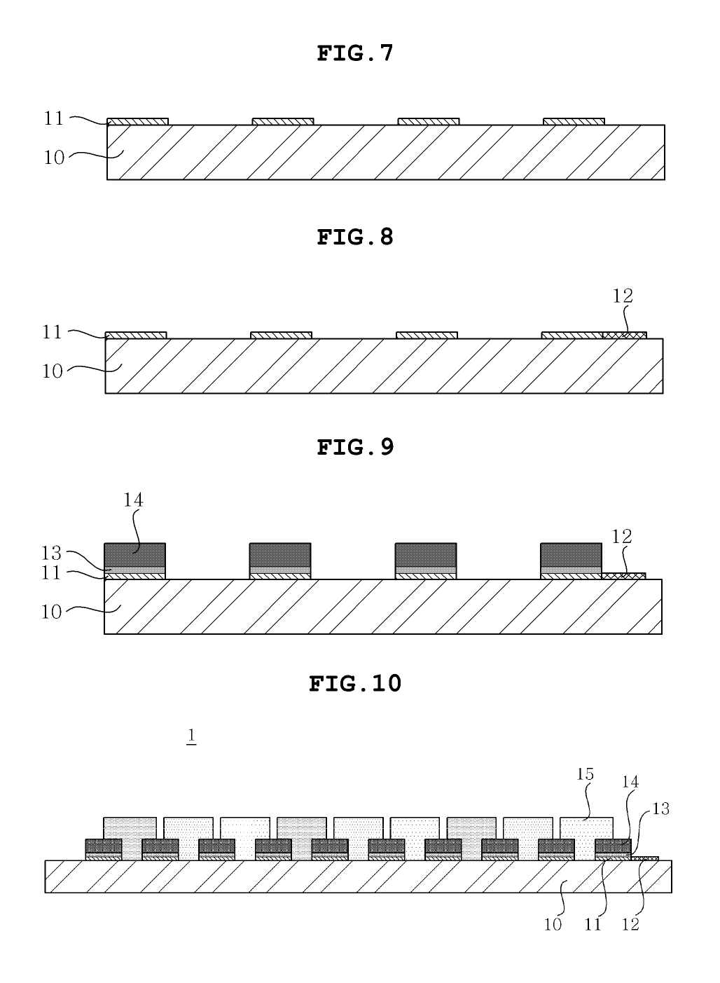

FIGS. 7 to 10 are diagrams showing a method for manufacturing a color filter substrate embedded with a touch sensor according to a preferred embodiment of the present invention in accordance with a process sequence.

The method for manufacturing a color filter substrate embedded with a touch sensor according to the preferred embodiment of the present invention includes providing a transparent substrate 10 and forming a metal mesh electrode 11 formed on the transparent substrate 10, forming the black matrix layer 14 with at least one opening area on the metal mesh electrode 11, and forming a color filter 15 to correspond to the opening area of the black matrix layer 14 and to be partially overlapped with the black matrix layer 14.

FIG. 7 is a diagram showing the step of forming the metal mesh electrode 11 on the transparent substrate 10. The metal mesh electrode 11 has a net shape in which a plurality of unit electrode lines having minute widths are arranged in parallel in a transverse direction and a longitudinal direction to cross each other vertically on the transparent substrate 10. The metal mesh electrode 11 may be formed by selectively etching a metal thin-film formed by a dry process such as sputtering, evaporation, or the like, and by a wet process such as dip coating, spin coating, roll coating, spray coating, or the like, or may be formed by using a direct patterning process such as screen printing, gravure printing, inkjet printing, or the like.

FIG. 8 is a diagram showing the step of forming the electrode wiring 12 on the metal mesh electrode 11. The electrode wiring 12 is formed to be extended from one side of the metal mesh electrode 11. Further, a material composed of silver (Ag) paste or organic silver having high electrical conductivity may be used as a material of the electrode wiring 12, but is not limited thereto and low-resistance metal such as a conductive polymer, carbon black (containing CNT), metal oxide such as ITO, metals, or the like, may be used. Meanwhile, when the electrode to wiring 12 is made of the same metal as the metal mesh electrode 11, the metal mesh electrode 11 and the electrode wring 12 may be simultaneously formed on the transparent substrate 10.

FIG. 9 is a diagram showing the step of forming an adhesive layer 13 on the metal mesh electrode 11 and forming the black matrix layer 14. The adhesive layer 13 is to improve an adhesion characteristic between the metal mesh electrode 11 and the black matrix layer 14 and a material of the adhesive layer 13 is not particularly limited, but an optical clear adhesive (OCA) or a double adhesive tape (DAT) may be used. The black matrix layer 14 formed on the adhesive layer 13 has a matrix shape in which longitudinal black lines and transverse black lines cross each other vertically, and a color filter 15 to be described below is applied to areas (opening areas) formed by crossing the longitudinal black lines and the transverse black lines. As described above, the metal mesh electrode 11 and the black matrix layer 14 may be overlapped with each other so that the pattern shape (including a line width and a width from the adjacent unit electrode line) of the metal mesh electrode 11 are completely the same as that of the black matrix layer 14 (see FIG. 6A), but the longitudinal black lines and the transverse black lines constituting the black matrix layer 14 do not all coincide with the longitudinal unit electrode lines and the transverse unit electrode lines of the metal mesh electrode 11. That is, the metal mesh electrode 11 may be partially overlapped with the black matrix layer 14 (see FIG. 6B). The black matrix layer 14 may be formed of Cr, a double layer film of Cr/CrOx, a resin, and graphite. Meanwhile, the screen printing may be used in order to form the black matrix layer 14 on the adhesive layer 13. That is, a printing mask (not shown) with a predetermined opening portion is placed on the transparent substrate 10, a black dispersion resin is printed by using a pressing tool (not shown) such as a squeeze, or the like, and the printing mask is then separated to thereby form the black matrix layer 14.

As shown in FIG. 10, a color filter 15 is formed in the opening area of the black matrix layer 14. Since the color filter 15 has three cells of red, green, and blue, separate pattern processes should be performed for each cell. That is, a red color filter 15 is formed by applying, selectively exposing, and developing a photoresist having a red color to the transparent substrate 10 as well as the opening area formed on the black matrix layer 14, a green color filter 15 is formed by applying, selectively exposing, and developing a photoresist having a green color to the transparent substrate 10 as well as the opening area, and a blue color filter 15 is formed by applying, selectively exposing, and developing a photoresist having a blue color to the transparent substrate 10 as well as the opening area.

Meanwhile, an overcoat layer may be further applied in order to flatten the surface of the color filter 15, as necessary.

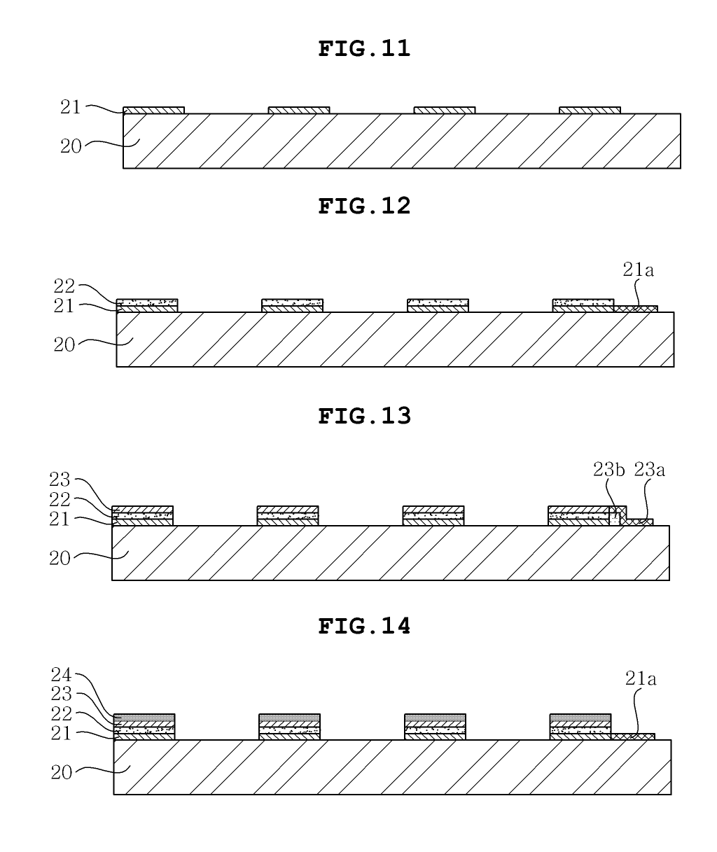

FIGS. 11 to 16 are diagrams showing a method for manufacturing a color filter substrate embedded with a touch sensor according to another preferred embodiment of the present invention in accordance with a process sequence.

In the method for manufacturing the color filter substrate embedded with a touch sensor according to another preferred embodiment of the present invention, the color filter substrate may be manufactured by forming metal mesh electrodes 21 and 23 as two layers of a first metal mesh electrode 21 and a second metal mesh electrode 23.

Hereinafter, the method for manufacturing the color filter substrate embedded with the touch sensor by forming the metal mesh electrodes 21 and 23 as the first metal mesh electrode 21 and the second metal mesh electrode 23 will be described. A detailed description of the same part as the manufacturing method of the color filter substrate embedded with the touch sensor according to the preferred embodiment of the present invention will be omitted.

First, as shown in FIG. 11, a transparent substrate 20 is provided, and a first metal mesh electrode 21 is formed on the surface of the transparent substrate 20. The first metal mesh electrode 21 has a net shape in which a plurality of unit electrode lines having minute widths are arranged in parallel in a transverse direction and a longitudinal direction to cross each other vertically on the transparent substrate 20. Since the forming method of the first mesh electrode 21 is the same as the method described above, it will not be described below.

Next, as shown in FIG. 12, an insulating layer 22 is formed on the first metal mesh electrode 21 to correspond to the first metal mesh electrode 21. The insulating layer 22 serves to electrically insulate the first metal mesh electrode 21 and a second metal mesh electrode 23 to be described below from each other and has the same shape as the first metal mesh electrode 21 to be overlapped with the first metal mesh electrode 21. A plasma enhanced chemical vapor deposition (PECVD) method may be used in order to form the insulating layer 22. In this case, a first electrode wiring 21a is formed to be extended from one side of the first metal mesh electrode 21. Further, a material composed of silver (Ag) paste or organic silver having high electrical conductivity may be used as a material of the first electrode wiring 21a, but is not limited thereto and low-resistance metal such as a conductive polymer, carbon black (containing CNT), metal oxide such as ITO, metals, or the like, may be used. Meanwhile, when the first electrode wiring 21a is made of the same metal as the first metal mesh electrode 21, the first metal mesh electrode 21 and the first electrode wring 21a may be simultaneously formed on the transparent substrate 20.

Next, as shown in FIG. 13, the second metal mesh electrode 23 is formed on the insulating layer 22 to correspond to the insulating layer 22. (For reference, FIG. 13 shows a cross-sectional view taken along line B-B′ of FIG. 6B in order to more clearly describe shapes of the second metal mesh electrode 23 and the second electrode wiring 23a). The second metal mesh electrode 23 has the net shape in which the plurality of unit electrode lines having minute widths are arranged in parallel in the transverse direction and the longitudinal direction to cross each other vertically and has the same shape as the first metal mesh electrode 21. In addition, in order to minimize the above-mentioned moire phenomenon, the second metal mesh electrode 23 is overlapped to be matched with the first metal mesh electrode 21. Since a forming method of the second metal mesh electrode 23 is the same as that of the first metal mesh electrode 21, a duplicated description will be omitted. Meanwhile, a second electrode wiring 23a is formed to be extended from one side of the second metal mesh electrode 23. In this case, structurally, since the second metal mesh electrode 23 is formed not directly on the surface of the transparent substrate 20 but on the insulating layer 22 formed on the first metal mesh electrode 21, an insulating material 23b should be first formed so that the first metal mesh electrode 21 and the second metal mesh electrode 23 are electrically insulated from each other. Thereafter, the second electrode wiring 23a is formed to be extended to the transparent substrate 20 so as to pass through the surface of the insulating material 23b.

A material composed of silver (Ag) paste or organic silver having high electrical conductivity may be used as a material of the second electrode wiring 23a, but is not limited thereto and low-resistance metal such as a conductive polymer, carbon black (containing CNT), metal oxide such as ITO, metals, the like, may be used. Further, when the second electrode wiring 23a is made of the same metal as the second metal mesh electrode 23, the second metal mesh electrode 23 and the second electrode wring 23a may be simultaneously formed.

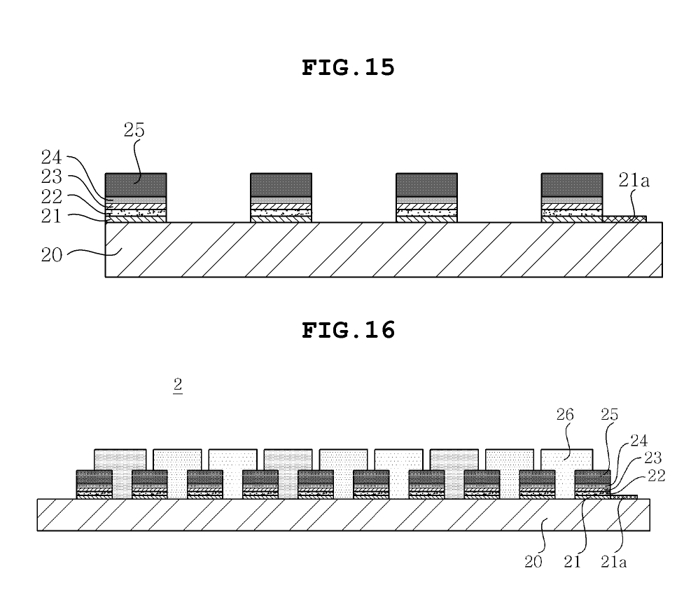

Next, as shown in FIG. 14, the adhesive layer 24 is formed on the second meal mesh electrode 23 and as shown in FIG. 15, the black matrix layer 25 is formed on the adhesive layer 24. The adhesive layer 24 is to improve an adhesion characteristic between the second metal mesh electrode 23 and the black matrix layer 25, and a material of the adhesive layer 24 is not particularly limited, but an optical clear adhesive (OCA) or a double adhesive tape (DAT) may be used. Meanwhile, the black matrix layer 25 formed on the adhesive layer 24 has a matrix shape in which longitudinal black lines and transverse black lines cross each other vertically, and a color filter 26 to be described below is applied to areas (opening areas) formed by crossing the longitudinal black lines and the transverse black lines. As described above, the metal mesh electrode and the black matrix layer 25 may be overlapped with each other so that the pattern shape (including a line width and a width from the adjacent unit electrode line) of the metal mesh electrode are completely the same as that of the black matrix layer 25 (see FIG. 6A), but the longitudinal black lines and the transverse black lines constituting the black matrix layer 25 do not all coincide with the longitudinal unit electrode lines and the transverse unit electrode lines of the metal mesh electrodes 21 and 23. That is, the metal mesh electrodes 21 and 23 may be partially overlapped with the black matrix layer 25 (see FIG. 6B). The black matrix layer 25 may be formed of Cr, a double layer film of Cr/CrOx, a resin, and graphite. Meanwhile, the screen printing may be used in order to form the black matrix layer 25 on the adhesive layer 24. That is, a printing mask (not shown) with a predetermined opening portion is placed on the transparent substrate 20, a black dispersion resin is printed by using a pressing tool (not shown) such as a squeeze, or the like, and the printing mask is separated to thereby form the black matrix layer 25.

Next, as shown in FIG. 16, a color filter 26 is formed in the opening area of the black matrix layer 25. A detailed description thereof will be omitted since it is duplicated with the manufacturing method of the color filter substrate embedded with a touch sensor according to the preferred embodiment of the present invention.

A technological characteristic is in that the touch sensor is interposed between the transparent substrate 20 and the black matrix layer 25 constituting the color filter substrate to integrate the touch sensor and the color filter substrate with each other. The color filter substrate and the touch sensor constituting the image display device are integrally implemented with each other, thereby making it possible to make the overall thickness of the image display device thin. As a result, a manufacturing process is simplified and a manufacturing cost is saved by minimizing the use of unnecessary components.

According to the preferred embodiments of the present invention, a touch sensor is embedded in a color filter substrate, thereby making it possible to make an image display device thin.

Further, according to the preferred embodiments of the present invention, the color filter substrate and the touch sensor are integrally formed with other, thereby making it possible to simplify a manufacturing process and save a manufacturing cost through minimization of consumption of an unnecessary component.

In addition, a metal mesh electrode and a black matrix are overlapped to be matched with each other, thereby making it possible to solve a moire phenomenon.

Although the embodiments of the present invention regarding a color filter substrate embedded with a touch sensor and a method for manufacturing the same have been disclosed for illustrative purposes, those skilled in the art will appreciate that a variety of different modifications, additions and substitutions are possible, without departing from the scope and spirit of the invention as disclosed in the accompanying claims.

Accordingly, such modifications, additions and substitutions should also be understood as falling within the scope of the present invention.

What is claimed is:

1. A color filter substrate embedded with a touch sensor, comprising:
a transparent substrate;
a metal mesh electrode formed on the transparent substrate; and
a black matrix layer formed on the metal mesh electrode to correspond to a shape of the metal mesh electrode and having at least one opening area formed therein.

2. The color filter substrate embedded with a touch sensor as set forth in claim 1, further comprising a color filter formed to correspond to the opening area of the black matrix layer and to be partially overlapped with the black matrix layer.

3. The color filter substrate embedded with a touch sensor as set forth in claim 1, wherein the metal mesh electrode includes:
a first metal mesh electrode formed on the transparent substrate;
an insulating layer formed on the first metal mesh electrode; and
a second metal mesh electrode formed on the insulating layer.

4. The color filter substrate embedded with a touch sensor as set forth in claim 3, wherein the second metal mesh electrode has a shape corresponding to that of the first metal mesh electrode and is overlapped to be matched with the first metal mesh electrode.

5. The color filter substrate embedded with a touch sensor as set forth in claim 3, wherein the insulating layer is stacked to correspond shapes of the first and second metal mesh electrodes.

6. The color filter substrate embedded with a touch sensor as set forth in claim 3, wherein the black matrix has a shape corresponding to those of the first and second metal mesh electrodes and is overlapped to be matched with the first and second metal mesh electrodes.

7. The color filter substrate embedded with a touch sensor as set forth in claim 3, wherein the second metal mesh electrode and the black matrix layer are adhered by an adhesive layer.

8. A method for manufacturing a color filter substrate embedded with a touch sensor, comprising:
providing a transparent substrate and forming a metal mesh electrode on the transparent substrate;
forming a black matrix layer with at least one opening area on the metal mesh electrode;
forming a color filter to correspond to the opening area of the black matrix layer and to be partially overlapped with the black matrix layer.

9. The method for manufacturing a color filter substrate embedded with a touch sensor as set forth in claim 8, wherein the metal mesh electrode has a shape corresponding to that of the black matrix layer.

10. A method for manufacturing a color filter substrate embedded with a touch sensor, comprising:
providing a transparent substrate and forming a first metal mesh electrode on a surface of the transparent substrate;
forming an insulating layer on the first metal mesh electrode to correspond to the first metal mesh electrode;
forming a second metal mesh electrode on the insulating layer to correspond to the insulating layer; and
forming a black matrix layer having a predetermined opening area on the second metal mesh electrode.

11. The method for manufacturing a color filter substrate embedded with a touch sensor as set forth in claim 10, wherein the second metal mesh electrode has a shape corresponding to that of the first metal mesh electrode and is overlapped to be matched with the first metal mesh electrode.

12. The method for manufacturing a color filter substrate embedded with a touch sensor as set forth in claim 10, wherein the black matrix layer has a shape corresponding to thoes of the first and second metal mesh electrodes and is overlapped to be matched with the first and second metal mesh electrodes.

13. The method for manufacturing a color filter substrate embedded with a touch sensor as set forth in claim 10, wherein the forming of the black matrix layer having the predetermined opening area on the second metal mesh electrode includes:
forming an adhesive layer on the second metal mesh electrode; and
stacking the black matrix layer on the adhesive layer.
